(19) United States
(12) Patent Application Publication
(10) Pub. No.: US 2022/0333558 A1
(43) Pub. Date: Oct. 20, 2022

(54) CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 17/716,561

(22) Filed: Apr. 8, 2022

(30) Foreign Application Priority Data
Apr. 16, 2021 (JP) 2021-069774

(51) Int. Cl. F02M 25/08; B01D 53/04

(52) U.S. Cl. CPC F02M 25/0854; B01D 53/0415; B01D 53/0446; B01D 2253/102; B01D 2257/702; B01D 2259/40086

(57) ABSTRACT

A canister, mounted in a vehicle with an engine and including one or more chambers, includes adsorbents, an inflow port, an atmosphere port, an outflow port, two or more adjusting portions, and one or more coupling portions. The two or more adjusting portions are elongated members placed in at least one target chamber of one or more chamber togethers, together with corresponding one adsorbent among the adsorbents to the target chamber. The one or more coupling portions couple the two or more adjusting portions to one another. Furthermore, the one or more coupling portions are provided to the two or more adjusting portions at a position distanced from end surfaces of the two or more adjusting portions.

### CROSS-REFERENCE TO RELATED APPLICATIONS

This application claims the benefit of Japanese Patent Application No. 2021-069774 filed on Apr. 16, 2021 with the Japan Patent Office, the entire disclosure of which is incorporated herein by reference.

### BACKGROUND

The present disclosure relates to a canister.

There is a known canister having an adsorbent such as activated carbon placed therein. Japanese Patent No. 6591955 (JP6591955B2) discloses an adjusting member arranged in a specified chamber of a canister. The adjusting member includes two or more rod-shaped portions having an elongated shape, and a single coupling portion. The single coupling portion is arranged so as to couple respective one ends of the two or more rod-shaped portions to one another. Each rod-shaped portion smooths, in the vicinity thereof, a flow of a fuel vapor flowing into the canister and a flow of a purge air.

### SUMMARY

In an extending direction (that is, a direction orthogonal to a flow direction of gas) of an adsorbent filled in a chamber of a canister, the higher the degree of uniformity of gas flow velocity, the adsorbent exhibits better adsorption performance. This is because since an adsorbent placed in an area of a higher gas flow velocity adsorbs a large amount of fuel vapor at an earlier stage, a capacity of such an adsorbent to adsorb the fuel vapor becomes smaller at an earlier stage. For this reason, the fuel vapor is not adsorbed in the area of the higher gas flow velocity and breakthrough of the fuel vapor thus occurs even if an adsorbent placed in another area has an enough capacity to perform the adsorption. The higher the rate of the adjusting member occupying a cross-section in the extending direction, the degree of uniformity of the gas flow velocity becomes lower. Since the canister of JP6591955B2 has the two or more rod-shaped portions arranged therein, the ventilation resistance is sufficiently reduced. However, it is also desired to reduce breakthrough of the fuel vapor and to advantageously perform fuel adsorption and desorption.

In one aspect of the present disclosure, it is desirable to provide a technique to reduce ventilation resistance of a canister while advantageously performing fuel adsorption and desorption.

One aspect of the present disclosure is a canister mounted in a vehicle with an engine and including one or more chambers. The canister comprises adsorbents, an inflow port, an atmosphere port, an outflow port, two or more adjusting portions, and one or more coupling portions. The inflow port flows a fuel vapor into the one or more chambers from a fuel tank of the vehicle. Each adsorbent of the adsorbents is placed in a corresponding chamber of the one or more chambers. The adsorbents adsorb the fuel vapor. The atmosphere port flows an atmosphere into the one or more chambers from an outside of the vehicle. The outflow port releases the fuel vapor adsorbed by the adsorbents to the engine using the atmosphere flowing in from the atmosphere port. The two or more adjusting portions are elongated members placed in at least one target chamber of the one or more chambers, together with corresponding one adsorbent among the adsorbents to the target chamber. The one or more coupling portions couple the two or more adjusting portions to one another. Furthermore, the one or more coupling portions are provided to the two or more adjusting portions at a position distanced from end surfaces of the two or more adjusting portions.

In the configuration above, the one or more coupling portions are not on (or proximal to) the end surfaces of the two or more adjusting portions. This inhibits generation of an uneven flow of the atmosphere and the fuel vapor near the end surfaces of the two or more adjusting portions. By reducing the uneven flow near an end of the target chamber, breakthrough of the fuel vapor can be reduced as compared to a case where a flow of the atmosphere and the fuel vapor is greatly uneven near the end of the target chamber. Accordingly, it is possible to reduce ventilation resistance of the canister while advantageously performing fuel adsorption and desorption.

In the above-described canister, the two or more adjusting portions may linearly extend in the same direction or approximately the same direction. Such a configuration can encourage the flow of the atmosphere and the fuel vapor in the same direction. Accordingly, it is possible to reduce ventilation resistance of the canister.

In the above-described canister, the two or more adjusting portions and the one or more coupling portions may be formed as one integral member. In such a configuration, it is possible to firmly couple the two or more adjusting portions and the one or more coupling portions to one another.

In the above-described canister, the one or more coupling portions may be formed at an approximately center of the two or more adjusting portions in a flow direction of the atmosphere and the fuel vapor. In such a configuration, it is possible to advantageously reduce the uneven flow of the atmosphere and the fuel vapor.

In the above-described canister, two or more coupling portions of the one or more coupling portions may be arranged to be distributed at two or more positions in a flow direction of the atmosphere and the fuel vapor. In filling the adsorbent in the target chamber, such a configuration inhibits the adsorbent from being obstructed by the two or more coupling portions. Thus, it is possible to smoothly fill the adsorbent.

In the above-described canister, when the two or more adjusting portions and the one or more coupling portions are projected on a plane of the two or more adjusting portions orthogonal to a flow direction of the atmosphere and the fuel vapor, a shape projected on the plane may have a point symmetry. In such a configuration, in assembling the two or more adjusting portions and the one or more coupling portions to the canister, even if the assembling is performed in a state (rotated state) where the two or more adjusting portions and the one or more coupling portions are rotated by 180 degrees about an axis along the flow direction, the position of the two or more adjusting portions remain the same. Even if the assembling is performed in the rotated state, there is only a small change in the flow of the fuel vapor. Accordingly, the configuration allows such assembling and can therefore facilitate the assembling.

In the above-described canister, the one or more coupling portions may be arranged diagonally with respect to the two or more adjusting portions. In filling the adsorbent in the target chamber, such a configuration inhibits the adsorbent from being obstructed by the one or more coupling portions. Accordingly, it is possible to smoothly fill the adsorbent.

### BRIEF DESCRIPTION OF THE DRAWINGS

Example embodiments of the present disclosure will be described hereinafter with reference to the accompanying drawings, in which:

FIG. 1 is a cross-section of a canister according to a first embodiment as viewed laterally;

FIG. 2A is a perspective view of an adjusting member according to the first embodiment;

FIG. 2B is a cross-section of the adjusting member according to the first embodiment along a line IIB-IIB in FIG. 2A;

FIG. 3A is a perspective view of the adjusting member according to the first embodiment;

FIG. 3B is a perspective view of the adjusting member according to the first embodiment;

FIG. 4A is a perspective view of a rod-shaped portion of the adjusting member according to a modified example;

FIG. 4B is a perspective view of the rod-shaped portion of the adjusting member according to the modified example;

FIG. 4C is a perspective view of the rod-shaped portion of the adjusting member according to the modified example;

FIG. 4D is a perspective view of the rod-shaped portion of the adjusting member according to the modified example;

FIG. 4E is a perspective view of the rod-shaped portion of the adjusting member according to the modified example;

FIG. 4F is a perspective view of the rod-shaped portion of the adjusting member according to the modified example;

FIG. 4G is a perspective view of a pellet;

FIG. 5 is a schematic diagram illustrating that the adjusting member is being formed by injection molding;

FIG. 6 is a schematic diagram illustrating that the adjusting member is formed so as to be lengthened in a single direction;

FIG. 7 is a cross-section of a canister according to a second embodiment as viewed laterally;

FIG. 8A is a perspective view of an adjusting member according to the second embodiment;

FIG. 8B is a cross-section of the adjusting member according to the second embodiment along a line VIIIB-VIIIB in FIG. 8A;

FIG. 8C is a cross-section of the adjusting member according to the second embodiment along a line VIIIC-VIIIC in FIG. 8A;

FIG. 9A is a perspective view of the adjusting member according to the second embodiment;

FIG. 9B is a perspective view of the adjusting member according to the second embodiment;

FIG. 10A is a front view of an adjusting member according to a third embodiment;

FIG. 10B is a side view of the adjusting member according to the third embodiment;

FIG. 10C is a perspective view of the adjusting member according to the third embodiment;

FIG. 10D is a cross-section of the adjusting member according to the third embodiment along a line XD-XD in FIG. 10B;

FIG. 11A is a front view of an adjusting member according to a modified example;

FIG. 11B is a side view of the adjusting member according to the modified example;

FIG. 11C is a perspective view of the adjusting member according to the modified example; and

FIG. 11D is a cross-section of the adjusting member according to the modified example in a line XID-XID in FIG. 11B.

### DETAILED DESCRIPTION OF EXEMPLARY EMBODIMENTS

### 1. First Embodiment

### 1-1. Configuration

[Configuration of Canister]

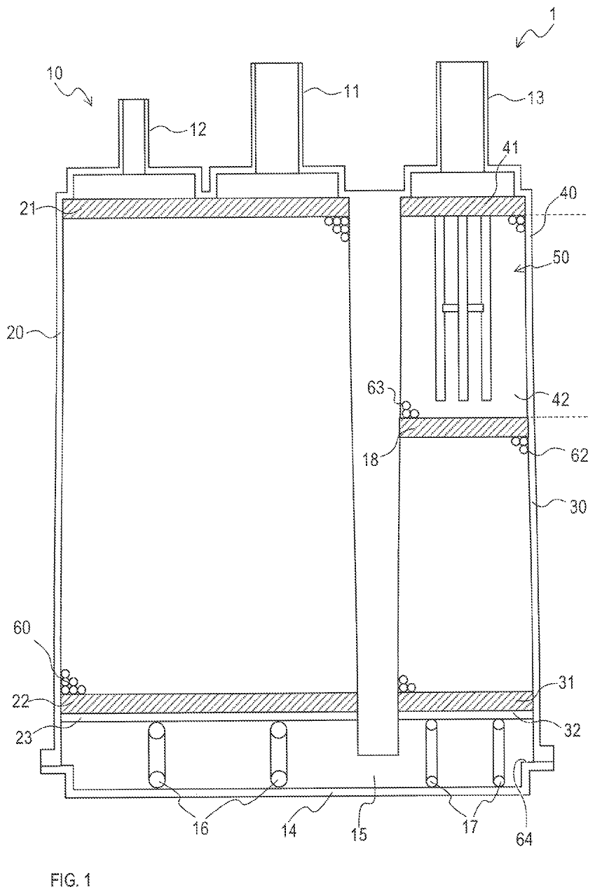

As shown in FIG. 1, there is provided a canister 1 in the first embodiment. The canister 1 is mounted in a vehicle with an engine (not shown). The canister 1 includes a casing 10 made of synthetic resin. The casing 10 comprises first through third chambers 20 through 40. Each chamber of the first through third chambers 20 through 40 includes an internal space. In the internal spaces of the first through third chambers 20 through 40, respectively, first through third adsorbents 60, 62, 63 to adsorb a fuel vapor are placed. The first through third adsorbents 60, 62, 63 are an aggregate of two or more substances in powdered or granular forms. Examples of the two or more substances may include activated carbon and substances generated from activated carbon. Furthermore, examples of the two or more substances are not limited to activated carbon and may be any substances that can adsorb a fuel vapor. The first through third adsorbents 60, 62, 63 may be of the same kind or different kinds.

The casing 10 has one end provided with an inflow port 11, an outflow port 12, and an atmosphere port 13. The internal space of the first chamber 20 communicates with the outside of the casing 10 via the inflow port 11 and the outflow port 12. Furthermore, the internal space of the third chamber 40 communicates with the outside of the casing 10 via the atmosphere port 13.

The inflow port 11 is coupled to a fuel tank (illustration omitted) of the vehicle. The fuel tank stores a fuel to be supplied to the engine of the vehicle. A fuel vapor generated from the fuel flows into the canister 1 via the inflow port 11 and is then adsorbed by the first through third adsorbents 60, 62, 63 placed in the first through third chambers 20 through 40, respectively. Consequently, the fuel is accumulated inside the canister 1.

The outflow port 12 is coupled to an intake pipe (illustration omitted) of the engine of the vehicle. The outflow port 12 releases the fuel vapor adsorbed by the first through third adsorbents 60, 62, 63 to the engine using an atmosphere flowing in from the atmosphere port 13. The atmosphere port 13 communicates with the outside of the vehicle. The atmosphere port 13 flows the atmosphere (hereinafter, referred to as “purge air”) into the canister 1 using engine intake manifold vacuum. Due to an inflow of the purge air, the fuel vapor adsorbed by the first through third adsorbents 60, 62, 63 (hereinafter, referred to as “desorbed fuel vapor”) is desorbed. The desorbed fuel vapor is released with the purge air through the outflow port 12 toward the intake pipe. Consequently, the fuel vapor adsorbed by the activated carbon is removed, and the activated carbon is regenerated. Regenerating activated carbon in such a manner is referred to as “purge”.

Detailed descriptions are given to a configuration of the canister 1. The casing 10 of the canister 1 includes first and second sides. Hereinafter, the first side, at which the inflow port 11, the outflow port 12, and the atmosphere port 13 are provided, is referred to as “port side”. The casing 10 includes an opening 64 at the second side opposite to the port side. The opening 64 is closed with a lid member 14. Hereinafter, the second side (that is, the side, at which the lid member 14 is provided) opposite to the port side is referred to as “lid side”.

In one example, the first chamber 20 is formed into an approximately rectangular parallelepiped shape or a cylindrical shape. The first chamber 20 is defined by a port side end communicating with the inflow port 11 and the outflow port 12. The port side end of the first chamber 20 is provided with a filter 21. The first chamber 20 is defined by a lid side end provided with a filter 22. The filters 21, 22 interpose the first adsorbent 60 therebetween.

The lid side end of the first chamber 20 communicates with a communication passage 15. The communication passage 15 extends along the lid member 14 and allows the first and second chambers 20, 30 to communicate with each other. At the lid side end of the chamber 20, the filter 22 and the communication passage 15 interpose, therebetween, a porous plate 23 having permeability to pass the fuel vapor and the purge air therethrough. Furthermore, the porous plate 23 and the lid member 14 interpose a coil spring 16 therebetween. The coil spring 16 presses the porous plate 23 toward the port side. Fluid can travel between the first and second chambers 20, 30 inside the canister 1 through the communication passage 15.

The second and third chambers 30, 40 are placed adjacent to the first chamber 20. The second and third chambers 30, 40 have an elongated shape extending from the lid side to the port side. Each of the second and third chambers 30, 40 is defined by a port side end and a lid side end. The second and third chambers 30, 40 are aligned in this order in a lid-to-port direction with the port side end of the second chamber 30 and the lid side end of the third chamber 40 being adjacent to each other. The second and third chambers 30, 40 are partitioned by a partitioning member 18 formed into a plate shape. The partitioning member 18 has permeability to pass the fuel vapor and the purge air therethrough. The partitioning member 18 may include, for example, a porous plate and/or a filter. The fluid can pass through the partitioning member 18 and travel between the second and third chambers 30, 40 inside the canister 1.

The lid side end of the second chamber 30 is provided with a filter 31. The port side end of the third chamber 40 is provided with a filter 41. In the second chamber 30, the filter 31 and the partitioning member 18 interpose the second adsorbent 62 therebetween. In the third chamber 40, the filter 41 and the partitioning member 18 interpose the third adsorbent 63 therebetween.

The filter 31 and the communication passage 15 interpose a porous plate 32 having permeability to pass the fuel vapor and the purge air therethrough. The porous plate 32 and the lid member 14 interpose a coil spring 17 therebetween. The coil spring 17 presses the porous plate 32 toward the port side.

The port side end of the third chamber 40 communicates with the atmosphere port 13. The third chamber 40 is an elongated space having a fixed width. In the first embodiment, in one example, the third chamber 40 is formed into a rectangular parallelepiped shape. However, the third chamber 40 may have a different shape. In one example, the third chamber 40 may be formed into a cylindrical shape.

[Regarding Adjusting Member]

In the present disclosure, there is at least one target chamber in one or more chambers provided to the canister 1. The target chamber is provided with an adjusting member 50 together with third adsorbent 63. In the first embodiment, the third chamber 40 is the target chamber in one example. Needless to say, the first chamber 20 or the second chamber 30 may be the target chamber in place of the third chamber 40. Furthermore, two or more chambers among the first through third chambers 20, 30, 40 may be target chambers. Hereinafter, descriptions are given to the adjusting member 50 placed in the third chamber 40.

As illustrated in FIG. 1, the adjusting member 50 is placed together with the third adsorbent 63 in the internal space of the third chamber 40 (hereinafter, referred to as “third space 42”).

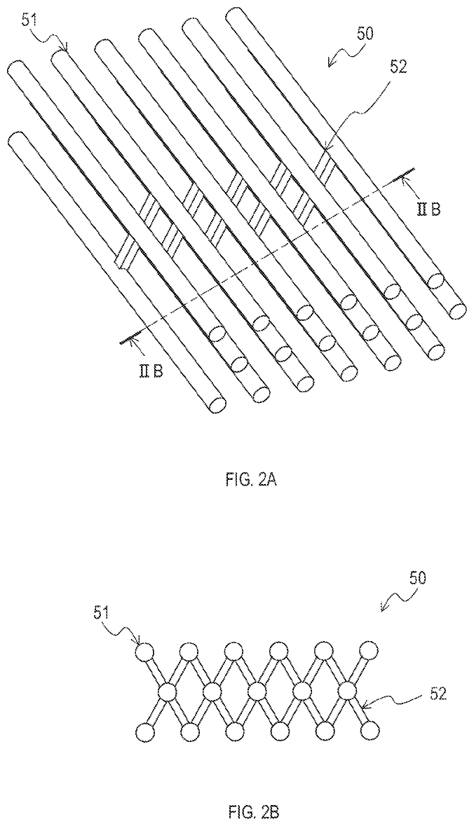

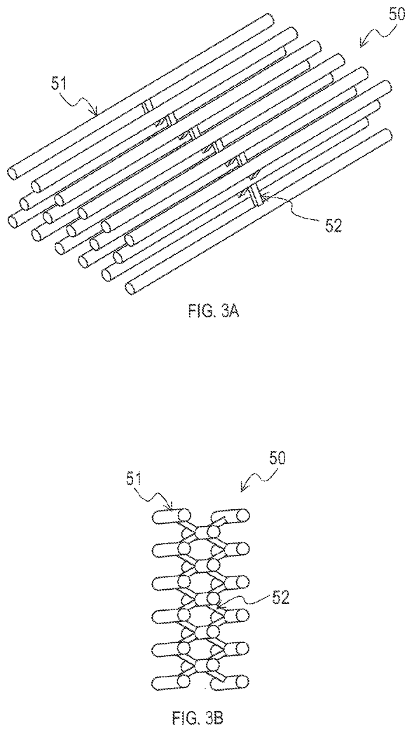

As illustrated in FIGS. 2A, 2B, 3A, 3B, the adjusting member 50 includes two or more rod-shaped portions 51 and a single coupling portion 52.

The two or more rod-shaped portions 51 extend linearly or approximately linearly. The term “approximately linearly” means that a whole of the two or more rod-shaped portions 51 is in the form of an approximately straight line. For example, a part of or the whole of the two or more rod-shaped portions 51 may be bent at a small curvature. In other words, examples of the two or more rod-shaped portions 51 include those in which the two or more rod-shaped portions 51 appear to be a straight line. Furthermore, the two or more rod-shaped portions 51 extend in the same direction or approximately the same direction. More specifically, the two or more rod-shaped portions 51 extend in a direction from the port side to the lid side of the third space 42 (port-to-lid direction), or a direction approximately the same as the port-to-lid direction. In other words, the two or more rod-shaped portions 51 are arranged along a direction in which the purge air and the fuel vapor flow (hereinafter, simply referred to as “flow direction”), or a direction approximately the same as the flow direction. That is, the two or more rod-shaped portions 51 has a longitudinal axis that may be the same as the flow direction, or that may have a small angle with respect to the flow direction.

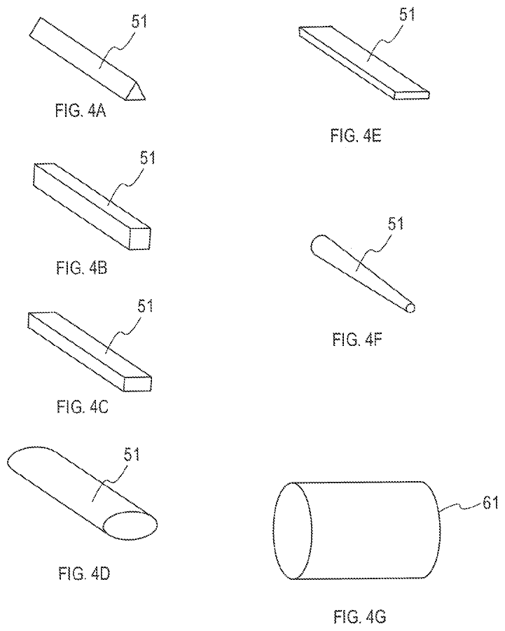

In one example, each rod-shaped portion 51 (hereinafter, simply referred to as “rod-shaped portion 51”) of the two or more rod-shaped portions 51 is formed into a columnar shape as illustrated in FIG. 2A. However, the rod-shaped portion 51 may be formed into a different shape. Specifically, example shapes of the rod-shaped portion 51 may include a polygonal columnar shape and more specifically, a triangular prism shape as illustrated in FIG. 4A, and a quadrangular prism shape having a square or a rectangular shape in a cross-section as illustrated in FIGS. 4B, 4C. Furthermore, example cross-sectional shapes of the rod-shaped portion 51 may include an oval shape as illustrated in FIG. 4D. Still further, example shapes of the rod-shaped portion 51 may include a band-like shape as illustrated in FIG. 4E and a tapered shape as illustrated in FIG. 4F.

The coupling portion 52 is provided to the two or more rod-shaped portions 51 at a position distanced from end surfaces of the two or more rod-shaped portions 51. In a case where end portions of the two or more rod-shaped portions 51 are formed to be sharp, tops of the end portions are defined as end surfaces. The coupling portion 52 couples the two or more rod-shaped portions 51 as one integral member. In the first embodiment, the coupling portion 52 is provided to an approximately center of the two or more rod-shaped portions 51 in the flow direction. The position and the orientation of the two or more rod-shaped portions 51 are fixed with respect to one another. Here, the term “approximately center of the two or more rod-shaped portions 51” means a vicinity of an intermediate position in the two or more rod-shaped portions 51 between the end surfaces closest to the port side and the end surfaces closest to the lid side.

Furthermore, the rod-shaped portion 51 has surrounding spaces (in other words, lateral spaces) communicating with one another. Specifically, adjacent rod-shaped portions 51 of the two or more rod-shaped portions 51 are placed with a given distance or more provided from each other. Since there is no area enclosed by the two or more rod-shaped portions 51 in the third space 42, there is no area isolated from other areas in the third space 42.

Furthermore, the two or more rod-shaped portions 51 are placed with a given distance or more provided from a wall (hereinafter, referred to as “side wall”) defining a lateral (or side) area of the third space 42. Still further, the two or more rod-shaped portions 51 are placed so as to pass through a center of the third space 42 in a width axis and its surrounding area.

The two or more rod-shaped portions 51 extend from an end surface defining the port side of the third space 42 (port side end surface) to an end surface defining the lid side of the third space 42 (lid side end surface). The port side and lid side end surfaces are walls defining ends of the third space 42. Specifically, one ends of the two or more rod-shaped portions 51 are located on or in the vicinity of the port side end surface defining the third space 42 (in other words, the filter 41). On the other hand, the other ends of the two or more rod-shaped portions 51 are located on or in the vicinity of the lid side end surface defining the third space 42 (in other words, the partitioning member 18).

The adjusting member 50 is surrounded by the third adsorbent 63. The third adsorbent 63 to be placed in the third chamber 40 may be an aggregate of two or more granular substances having a specified shape. Specifically, examples of the third adsorbent 63 may include an aggregate of two or more pellets 61. The two or more pellets 61 are granular activated carbon. The two or more pellets 61 are produced by kneading powdered activated carbon with a binder, and forming the powdered activated carbon kneaded into a specified shape. As illustrated in FIG. 4G, each pellet 61 of the two or more pellets 61 in the first embodiment is formed into a cylindrical shape in one example. In one example, the diameter of two base surfaces of the pellet 61 may be about 2 mm. Furthermore, in one example, the distance (in other words, the length) between the two base surfaces of the pellet 61 may be in a range of about 3 mm through 5 mm. The pellet 61 may have a different shape. Furthermore, an adsorbent different from the pellet 61 may be placed in the third chamber 40, such as powdered activated carbon.

The given distance between the adjacent rod-shaped portions 51 is determined based on a size of the pellet 61. Specifically, the given distance may be longer than, for example, the diameter of the two base surfaces of the pellet 61 or the length of the pellet 61.

Furthermore, the smallest value of the distance between a side part of the rod-shaped portion 51 and the side wall defining the third space 42 is also determined based on the size of the pellet 61. Specifically, the smallest value may be larger than, for example, a value of the diameter of the two base surfaces of the pellet 61 or a value of the length of the pellet 61. In other words, a distance(s) between a side part(s) of one or more outermost rod-shaped portions 51 of the two or more rod-shaped portions 51 and the side wall defining the third space 42 may be longer than, for example, the diameter of the two base surfaces of the pellet 61 or the length of the pellet 61.

### 1-2. Effects

The first embodiment described above can bring effects to be described below.

(1a) The coupling portion 52 is provided to the two or more rod-shaped portions 51 at the position distanced from the end surfaces of the two or more rod-shaped portions 51.

In such a configuration, the coupling portion 52 is not on (or proximal to) the end surfaces of the two or more rod-shaped portions 51. This inhibits generation of an uneven flow of the purge air and the fuel vapor near the end surfaces of the two or more rod-shaped portions 51. By reducing the uneven flow near an end of the target chamber, breakthrough of the fuel vapor can be reduced as compared to a case where the flow of the purge air and the fuel vapor is greatly uneven near the end of the target chamber. Accordingly, it is possible to reduce ventilation resistance of the canister 1 while advantageously performing fuel adsorption and desorption.

(1b) The two or more rod-shaped portions 51 linearly extend in the same direction or approximately the same direction. Such a configuration can encourage the flow of the purge air and the fuel vapor in the same direction. Accordingly, it is possible to reduce ventilation resistance of the canister 1.

(1c) The two or more rod-shaped portions 51 and the coupling portion 52 are formed as one integral member. In such a configuration, it is possible to firmly couple the two or more rod-shaped portions 51 and the coupling portion 52 to one another.

(1d) The coupling portion 52 is formed at the approximately center of the two or more rod-shaped portions 51 in the flow direction. In such a configuration, it is possible to advantageously reduce the uneven flow of the purge air and the fuel vapor.

### 1-3. Advantage in Producing Adjusting Member by Injection Molding

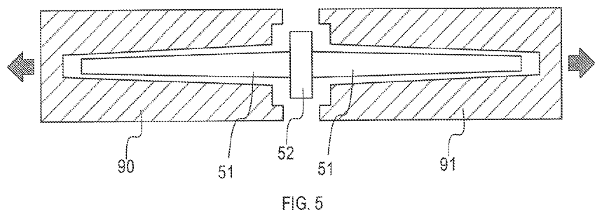

In one example, the two or more rod-shaped portions 51 and the coupling portion 52 can be produced by injection molding. The two or more rod-shaped portions 51 and the coupling portion 52 are formed as one integral member by injecting resin into a metallic mold including metallic molds 90, 91, and thereafter removing the metallic molds 90, 91 from both longitudinal sides of the two or more rod-shaped portions 51 produced (molded product) as illustrated in FIG. 5. In performing the production by injection molding, in order to smoothly remove the molded product from the metallic mold, a diameter of leading ends of the two or more rod-shaped portions 51 is reduced relative to a diameter of bases of the two or more rod-shaped portions 51 in proximity to the coupling portion 52.

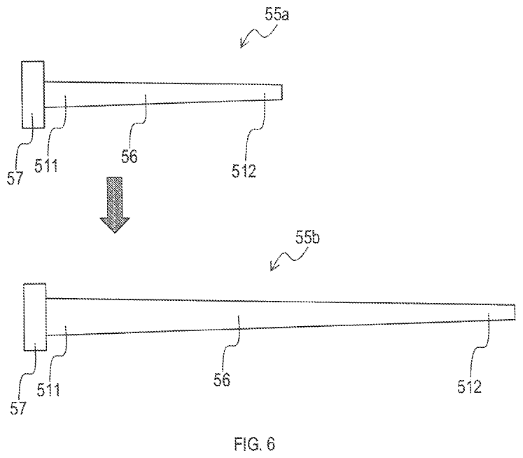

There is a consideration made to a solution to lengthen the two or more rod-shaped portions 51. FIG. 6 illustrates (i) an adjusting member 55a, in which a coupling portion 57 is provided to one ends of the two or more rod-shaped portions 56, and (ii) an adjusting member 55b, in which the two or more rod-shaped portions 56 have a longer length than the two or more rod-shaped portions 56 of the adjusting member 55a. In a case where the two or more rod-shaped portions 56 are lengthened as in the adjusting member 55b, molding defects are more prone to occur, as compared to the adjusting member 55a, when injection molding is performed. For example, in the adjusting member 55b, a diameter of ends 511 of the two or more rod-shaped portions 56 closer to the coupling portion 57 is larger than a diameter of leading ends 512 opposite to the ends 511. This results in a difference in thickness and a so-called sink mark is prone to be generated.

On the other hand, there is no such a disadvantage in the case of forming an adjusting member so as to provide the two or more rod-shaped portions 51 on both sides of the coupling portion 52 as in the first embodiment above. That is, the two or more rod-shaped portions 51 as a whole can be lengthened without increasing a difference between the diameter of the bases and the diameter of the opposing leading ends of the two or more rod-shaped portions 51. Thus, it is possible to form the adjusting member 50 having the two or more rod-shaped portions 51 lengthened while reducing occurrence of molding defects. Although FIGS. 5, 6 illustrate the two or more rod-shaped portions 51 having a tapered shape, each rod-shaped portion 51 may have a different shape.

### 2. Second Embodiment

### 2-1. Differences from First Embodiment

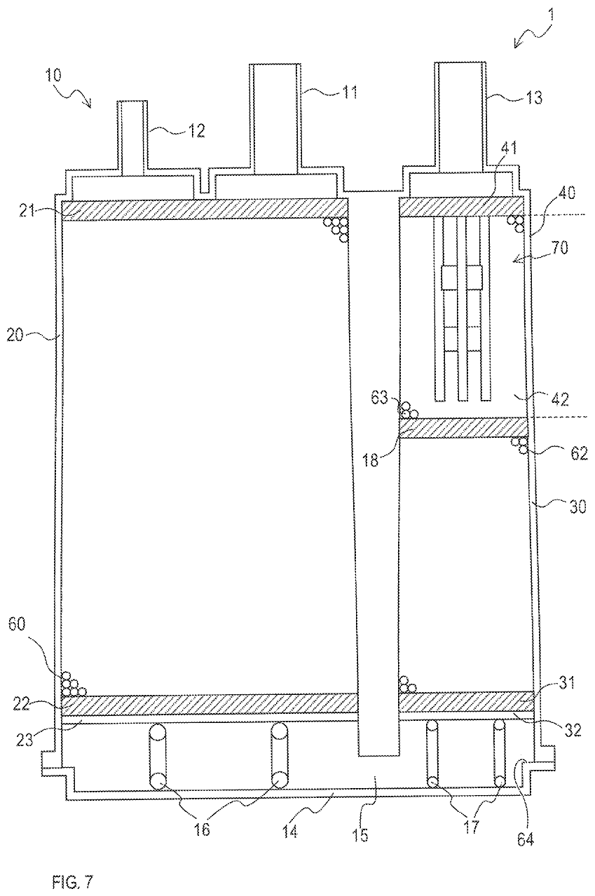

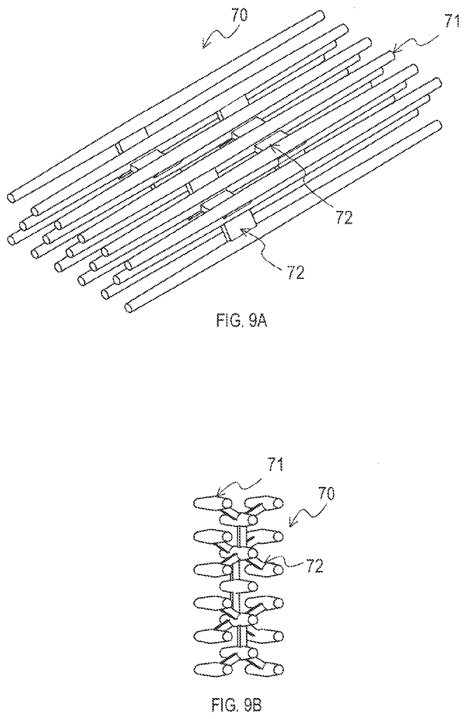

As illustrated in FIGS. 7 through 9, the canister 1 of the second embodiment is different from the canister 1 of the first embodiment in that an adjusting member 70 is provided in place of the adjusting member 50. The adjusting member 70 is different from the adjusting member 50 in respect of the configuration of coupling portion. Other parts of the canister 1 of the second embodiment have the same configurations as those of the first embodiment. Hereinafter, descriptions are given to differences of the canister 1 of the second embodiment from the canister 1 of the first embodiment.

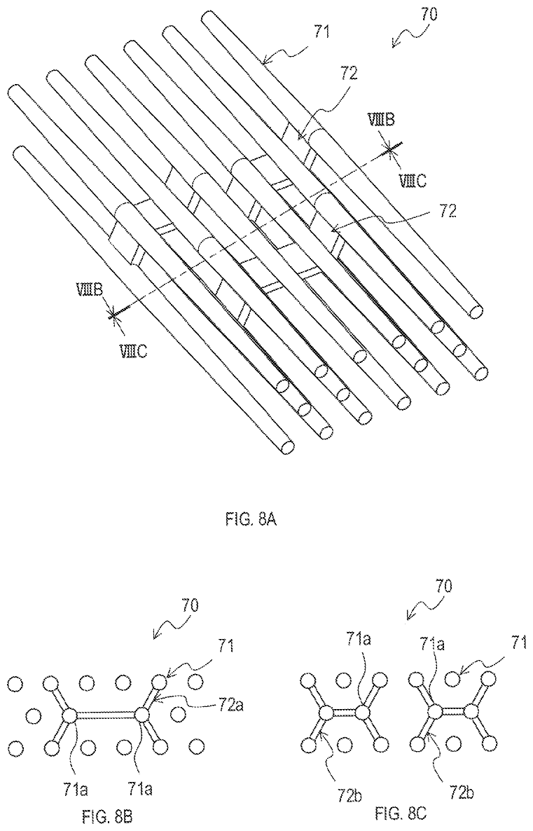

The adjusting member 70 includes two or more rod-shaped portions 71 and two or more coupling portions 72. The two or more coupling portions 72 are arranged to be distributed at two or more positions in the flow direction. In the present embodiment, the two or more coupling portions 72 include a coupling portion 72a and coupling portions 72b. The coupling portions 72a, 72b, respectively, are arranged to be distributed at first and second positions distinct from each other in the flow direction (longitudinal axis of the two or more rod-shaped portions 71). At the first position along the longitudinal axis, the coupling portion 72a couples six rod-shaped portions 71 to one another as illustrated in FIG. 8B. On the other hand, at the second position along the longitudinal axis, each of the coupling portions 72b couples the six rod-shaped portions 71 to one another as illustrated in FIG. 8C. Since two rod-shaped portions 71a of the two or more rod-shaped portions 71 are coupled to both of the coupling portions 72a, 72b, all of the two or more rod-shaped portions 71 are coupled to one another. When the two or more rod-shaped portions 71 and the two or more coupling portions 72 are projected on a plane orthogonal to the flow direction, a shape projected on the plane (projected shape) has a point symmetry.

### 2-2. Effects

The second embodiment can bring effects to be described below in addition to the effects of the first embodiment above.

(2a) The two or more coupling portions 72 are arranged to be distributed at the two or more positions in the flow direction. Such a configuration can provide more gaps between the two or more rod-shaped portions 71 and the two or more coupling portions 72, as compared to a case where two or more coupling portions are formed at the same position in the flow direction. That is, in filling the third adsorbent 63 in the target chamber, the third adsorbent 63 is inhibited from being obstructed by the two or more coupling portions 72. Accordingly, it is possible to smoothly fill the third adsorbent 63.

(2b) When the two or more rod-shaped portions 71 and the two or more coupling portions 72 are projected on the plane of the two or more rod-shaped portions 71 orthogonal to the flow direction, the projected shape has a point symmetry. In such a configuration, in assembling the two or more rod-shaped portions 71 and the two or more coupling portions 72 to the canister 1, even if the assembling is performed in a state (rotated state) where the two or more rod-shaped portions 71 and the two or more coupling portions 72 are rotated by 180 degrees about an axis along the flow direction, the position of the two or more rod-shaped portions 71 remain the same. Since there is only a small change in the flow of the fuel vapor even if the assembling is performed in the rotated state, this assembling is permitted. Consequently, it is possible to facilitate assembling of the canister 1.

### 3. Third Embodiment

### 3-1. Differences from First Embodiment

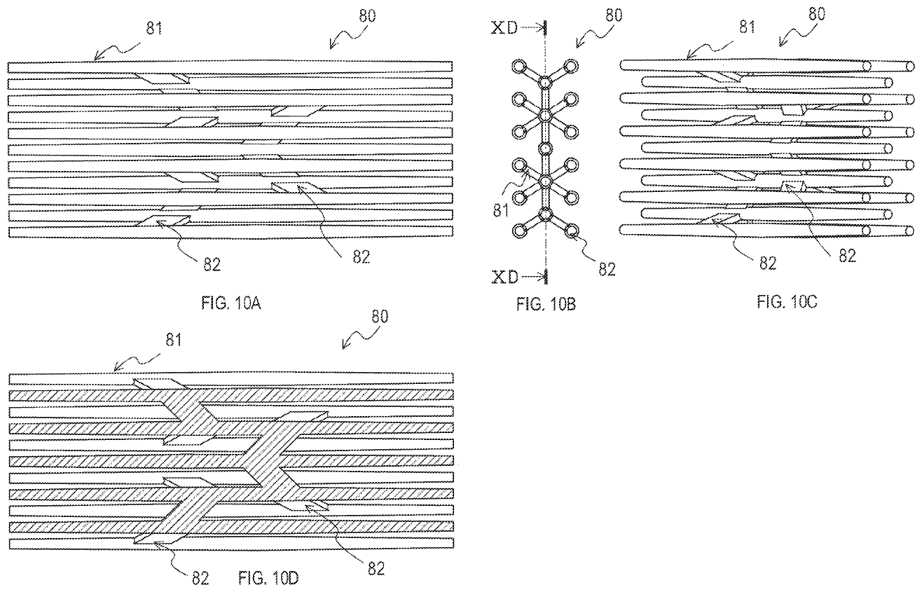

As illustrated in FIG. 10, the canister 1 of the third embodiment is different from the canister 1 of the first embodiment in that an adjusting member 80 is provided in place of the adjusting member 50. The adjusting member 80 is different from the adjusting member 50 in respect of the configuration of coupling portions. Other parts of the canister 1 of the third embodiment have the same configurations as those of the first embodiment. Hereinafter, descriptions are given to a difference of the canister 1 of the third embodiment from the canister 1 of the first embodiment.

The adjusting member 80 includes two or more rod-shaped portions 81 and two or more coupling portions 82. The two or more coupling portions 82 are arranged diagonally with respect to the two or more rod-shaped portions 81 in the flow direction.

### 3-2. Effect

The third embodiment can bring an effect to be described below in addition to the effects of the first embodiment above.

(3a) The two or more coupling portions 82 are arranged diagonally with respect to the two or more rod-shaped portions 81 in the flow direction. In such a configuration, in filling the third adsorbent 63 in the target chamber, the third adsorbent 63 slides on inclined surfaces of the two or more coupling portions 82 and thus easily falls downward. Accordingly, this inhibits the adsorbent 63 from being obstructed by the two or more coupling portions 82 and therefore, the third adsorbent 63 can be smoothly filled.

### 4. Other Embodiments

Although the embodiments of the present disclosure have been described hereinabove, the present disclosure is not limited to the above-described embodiments and may be practiced in various forms.

(4a) The canister 1 of the first through third embodiments includes three chambers. However, the canister 1 may include one chamber, two chambers, or four or more chambers. Even in these cases, at least one chamber may be configured as the target chamber, in which the adjusting member 50 is placed.

(4b) In the canister 1 of the first through third embodiments, the two or more rod-shaped portions 51, 71, 81 are placed in at least one target chamber while extending along the flow direction. Furthermore, the two or more rod-shaped portions 51, 71, 81 extend linearly or approximately linearly. However, the two or more rod-shaped portions 51, 71, 81 may extend in the flow direction in a state of, for example, being curved or bent at one or more locations. Furthermore, the two or more rod-shaped portions 51, 71, 81 may extend helically in the flow direction, for example. Still further, the two or more rod-shaped portions 51, 71, 81 may have different shapes.

Still further, the two or more rod-shaped portions 51, 71, 81 may extend in a direction different from the flow direction. The two or more rod-shaped portions 51 may extend in different directions from one another, and the same applies to the two or more rod-shaped portions 71, 81. If there are three or more rod-shaped portions 51, two rod-shaped portions 51 may extend in one direction, and the rest of the rod-shaped portion(s) 51 may extend in another direction.

(4c) The first through third embodiments exemplify a configuration in which the two or more rod-shaped portions 51, 71, 81 and the single or two or more coupling portions 52, 72, 82, respectively, are formed as one integral member. However, the two or more rod-shaped portions 51, 71, 81 and the single or two or more coupling portions 52, 72, 82, respectively, may not necessarily be formed as one integral member. For example, the two or more rod-shaped portions 51, 71, 81 and the single or two or more coupling portions 52, 72, 82, respectively, may be formed with different molds, or formed of different materials.

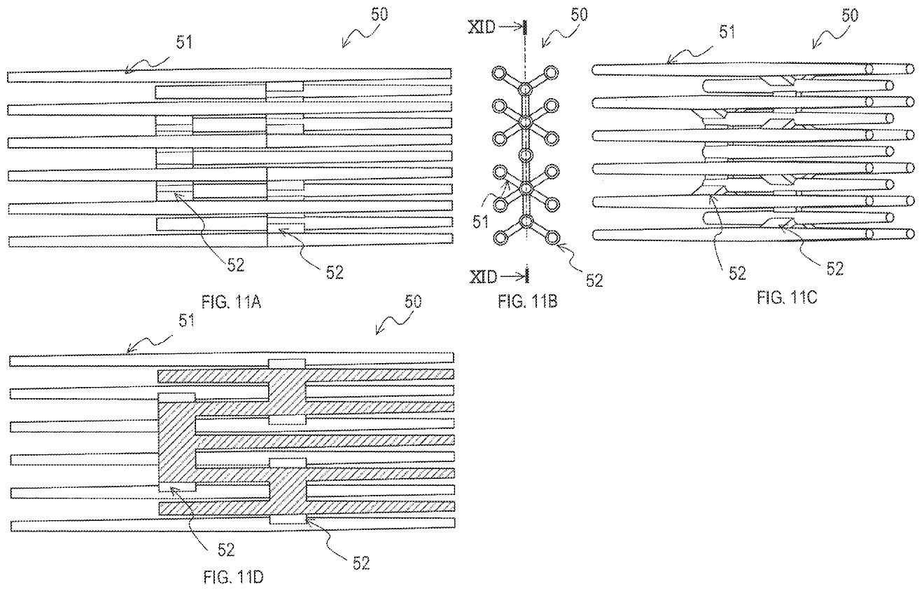

(4d) The first through third embodiments exemplify a configuration in which rod-shaped portions included in the two or more rod-shaped portions 51, 71, 81 have the same length. However, the rod-shaped portions in the rod-shaped portions 51, 71, 81 may have different lengths from one another. For example, as illustrated in FIG. 11A through FIG. 11D, inner rod-shaped portions of the two or more rod-shaped portions 51, 71, 81 may be designed to be shorter than outer rod-shaped portions of the two or more rod-shaped portions 51, 71, 81.

(4e) The first embodiment exemplifies a configuration in which the coupling portion 52 is provided to the approximately center of the two or more rod-shaped portions 51 in the flow direction. However, the position to provide the coupling portion 52 may not be limited thereto. For example, the coupling portion 52 may be provided to an intermediate point between the end surfaces and the center of the two or more rod-shaped portions 51.

(4f) The second embodiment exemplifies a configuration in which the two or more coupling portions 72 are arranged to be distributed at the two positions distinctive from each other in the flow direction. However, the positions to arrange the two or more coupling portions 72 may not be limited thereto. For example, the two or more coupling portions 72 may be arranged to be distributed at three or more positions distinctive from one another.

(4g) The second embodiment exemplifies a configuration in which the projected shape of the two or more rod-shaped portions 71 and the coupling portions 72 has a point symmetry when they are projected on the plane orthogonal to the flow direction. However, the projected shape of the two or more rod-shaped portions 71 and the two or more coupling portions 72, when they are projected on the flow direction, may not be limited thereto. For example, the projected shape may not have a point symmetry. Alternatively, the projected shape may have a line symmetry. Furthermore, the projected shape may not be symmetrical.

(4h) One or more functions of one element of the aforementioned embodiments may be distributed to two or more elements, and one or more functions of two or more elements may be integrated into one element. Furthermore, a part of the configurations of the aforementioned embodiments may be omitted. Still further, at least a part of the configurations of the aforementioned embodiments may be added to or replaced with configurations of the other above-described embodiments.

### 5. Corresponding Relationship

In the first through third embodiments, the two or more rod-shaped portions 51, 71, 81 correspond to one example of the two or more adjusting portions. The coupling portions 52, 72, 82 correspond to one example of the one or more coupling portions.

What is claimed is:

1. A canister mounted in a vehicle with an engine and including one or more chambers, the canister comprising:
an inflow port flowing a fuel vapor into the one or more chambers from a fuel tank of the vehicle;
adsorbents adsorbing the fuel vapor, each adsorbent of the adsorbents being placed in a corresponding chamber of the one or more chambers;
an atmosphere port flowing an atmosphere into the one or more chambers from an outside of the vehicle;
an outflow port releasing the fuel vapor adsorbed by the adsorbents to the engine using the atmosphere flowing in from the atmosphere port;
two or more adjusting portions having an elongated shape, the two or more adjusting portions being placed in at least one target chamber of the one or more chambers, together with corresponding one adsorbent among the adsorbents to the target chamber; and
one or more coupling portions coupling the two or more adjusting portions to one another,
wherein the one or more coupling portions are provided to the two or more adjusting portions at a position distanced from end surfaces of the two or more adjusting portions.

2. The canister according to claim 1, wherein the two or more adjusting portions linearly extend in the same direction or approximately the same direction.

3. The canister according to claim 1, wherein the two or more adjusting portions and the one or more coupling portions are formed as one integral member.

4. The canister according to claim 1, wherein the one or more coupling portions are formed at an approximately center of the two or more adjusting portions in a flow direction of the atmosphere and the fuel vapor.

5. The canister according to claim 1, wherein two or more coupling portions of the one or more coupling portions are arranged to be distributed at two or more positions in a flow direction of the atmosphere and the fuel vapor.

6. The canister according to claim 1, wherein when the two or more adjusting portions and the one or more coupling portions are projected on a plane orthogonal to a flow direction of the atmosphere and the fuel vapor, a shape projected on the plane has a point symmetry.

7. The canister according to claim 1, wherein the one or more coupling portions are arranged diagonally with respect to the two or more adjusting portions.
